(19) United States
(12) Patent Application Publication
(10) Pub. No.: US 2026/0212410 A1
(43) Pub. Date: Jul. 23, 2026

(54) METHOD AND SYSTEM FOR AI-BASED REAL-TIME ANALYSIS OF ENTITY DATA

(71) Applicant: Chris Levya, Sparks, NV (US)

(72) Inventor: Chris Levya, Sparks, NV (US)

(21) Appl. No.: 19/089,501

(22) Filed: Mar. 25, 2025

Related U.S. Application Data
(60) Provisional application No. 63/747,584, filed on Jan. 21, 2025.

(51) Int. Cl. G06Q 40/03; G06N 20/00; G06Q 40/02

(52) U.S. Cl. CPC G06Q 40/03; G06N 20/00; G06Q 40/02

(57) ABSTRACT

A system for an automated real-time analysis and generation of predictive entity scoring based on entity data including a processor of a predictive scoring server (PSS) node configured to host a machine learning (ML) module coupled to at least one target user-entity node and to a plurality of remote nodes associated with the at least one target entity node over a network and a memory on which are stored machine-readable instructions that when executed by the processor, cause the processor to: acquire target entity profile data from the at least one target entity node, the target entity profile data including action metrics associated with the at least one target entity and the plurality of remote nodes; perform normalization of the target entity profile data based on the action metrics; parse the normalized data to derive a plurality of classifying features; generate a feature vector based on the plurality of classifying features; ingest the feature vector into the ML module coupled to an Artificial Neural Network (ANN); receive a plurality of predictive scoring parameters from at least one entity scoring predictive model generated by the ML module using outputs of the ANN based on the feature vector; and generate at least one score for the at least one entity node based on the plurality of predictive scoring parameters.

### CROSS-REFERENCE TO RELATED APPLICATIONS

The present application claims priority to U.S. Provisional Patent Application No. 63/747,584 filed Jan. 21, 2024, titled “METHOD AND SYSTEM FOR AI-BASED REAL-TIME ANALYSIS OF ENTITY DATA,” which is hereby incorporated by reference in its entirety.

### FIELD OF DISCLOSURE

The present disclosure generally relates to entity analytics applications, and more particularly, to a system and method for an automated real-time analysis and generation of predictive entity scoring based on entity data.

### BACKGROUND

Automation of data science processes for analyzing entity-related data including financial data is commonly used.

In particular, conventional credit risk assessments determine the likelihood of a borrower defaulting on their loan obligations. This evaluation is critical for managing the bank's financial stability and involves a combination of quantitative and qualitative methods. Credit risk assessment conventional relies upon historical banking data including credit scoring, financial analysis, collateral valuation, credit history, risk models, regulatory guidelines, and loan terms.

Many conventional systems collect and analyze entity-related data for various purposes. For example, US 2015/0026061 A1 to Visa International Service Association details a real-time system for detecting transaction fraud using multiple scoring models running in parallel. The system receives transaction data and sends it to different models one for production use and the other for testing and development. Each model runs on its virtual machine and uses a virtual IP address, making switching models between environments easy without interrupting the system. The system tracks how well each model performs at detecting fraud and can automatically promote the best model to production by changing IP addresses. An important feature is that different clients (such as banks) can use other transaction models. This approach allows new fraud detection models to be tested with real-time data while the current system keeps running, making it easier to improve fraud detection over time while maintaining reliable operation.

U.S. Pat. No. 11,544,629 B2 to DoorDash Inc. details a machine learning system for ranking and recommending merchants to customers in a delivery logistics platform. The system operates in three key modes: training, inference, and update. In training mode, it learns from historical customer-merchant interaction data by extracting features like average order values, delivery times, and customer preferences, converting them into training vectors to determine weighted coefficients. In inference mode, when a customer searches for merchants, the system uses these learned coefficients to generate personalized ranking scores for available merchants, considering factors like location, cuisine preferences, and past ordering behavior. The update mode continuously refines the model's predictions by incorporating new order data and customer interactions in real-time. The system addresses two key challenges in local delivery marketplaces: the “cold start” problem for new users through a preference-based onboarding model, and data sparsity issues through a hybrid recommendation approach that combines explicit customer preferences with learned behavioral patterns. What makes this patent particularly innovative is its ability to adjust merchant rankings based on both historical patterns and real-time customer behavior, while also considering practical constraints like delivery radius and merchant availability.

As another example, U.S. Pat. No. 10,540,714 B1 to Capital One Services, LLC. details a cash flow analysis tool that helps financial institutions analyze customer transaction data to identify inefficient financial behaviors and recommend improvements. The system processes payables and receivables data streams and evaluates each transaction against defined thresholds, and assigns scores weighted by transaction type. Through a graphical interface, it displays inefficient activities like excessive check usage alongside recommendations for better practices, such as switching to electronic payments. The tool also assesses financial loss risks and calculates potential savings from adopting digital banking services. Users can interact with different sections of the interface—payables, receivables, and loss prevention-each showing efficient and inefficient behaviors through text and graphics. Key features include specialized calculators that demonstrate concrete benefits of changing payment methods, like converting check payments to credit card transactions, with clear displays of potential time and cost savings.

As yet another example, US 2024/0281812 A1 to Wells Fargo Bank details a fraud detection system that operates across multiple competing banks through an independent third-party organization. The system works by having banks share anonymized transaction data with this neutral organization, which then analyzes patterns across all participating banks to spot fraud that individual banks might miss. For example, if someone's stolen credit cards from different banks are being used simultaneously in different locations, each bank alone might not find this suspicious, but the cross-bank system can detect this pattern. When the system identifies potential fraud, it automatically alerts the relevant banks to block transactions and freeze the affected accounts. The system protects customer privacy and bank competition by using abstracted data and coded identifiers that prevent anyone from identifying specific customers or revealing sensitive bank information while enabling effective cross-bank fraud detection through analysis of transaction patterns and behaviors.

However, the existing systems are not accurate and may produce a lot of false positive/negative financial scoring and risk assessment estimates for various digital platforms and physical entities. These conventional systems do not use historical collected data and predictive data analytics to the fullest extent.

Accordingly, a system and method for AI-based automated real-time analysis and generation of predictive entity scoring based on entity data are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for an automated real-time analysis and generation of predictive entity scoring based on entity data including a processor of a predictive scoring server (PSS) node configured to host a machine learning (ML) module coupled to at least one target user-entity node and to a plurality of remote nodes associated with the at least one target entity node over a network and a memory on which are stored machine-readable instructions that when executed by the processor, cause the processor to: acquire target entity profile data from the at least one target entity node, the target entity profile data including action metrics associated with the at least one target entity and the plurality of remote nodes; perform normalization of the target entity profile data based on the action metrics; parse the normalized data to derive a plurality of classifying features; generate a feature vector based on the plurality of classifying features; ingest the feature vector into the ML module coupled to an Artificial Neural Network (ANN); receive a plurality of predictive scoring parameters from at least one entity scoring predictive model generated by the ML module using outputs of the ANN based on the feature vector; and generate at least one score for the at least one entity node based on the plurality of predictive scoring parameters.

Another embodiment of the present disclosure provides a method that includes one or more of: acquiring target entity profile data from the at least one target entity node, the target entity profile data including action metrics associated with the at least one target entity and the plurality of remote nodes; performing normalization of the target entity profile data based on the action metrics; parsing the normalized data to derive a plurality of classifying features; generating a feature vector based on the plurality of classifying features; ingesting the feature vector into the ML module coupled to an Artificial Neural Network (ANN); receiving a plurality of predictive scoring parameters from at least one entity scoring predictive model generated by the ML module using outputs of the ANN based on the feature vector; and generating at least one score for the at least one entity node based on the plurality of predictive scoring parameters.

Another embodiment of the present disclosure provides a computer-readable medium including instructions for: acquiring target entity profile data from the at least one target entity node, the target entity profile data including action metrics associated with the at least one target entity and the plurality of remote nodes; performing normalization of the target entity profile data based on the action metrics; parsing the normalized data to derive a plurality of classifying features; generating a feature vector based on the plurality of classifying features; ingesting the feature vector into the ML module coupled to an Artificial Neural Network (ANN); receiving a plurality of predictive scoring parameters from at least one entity scoring predictive model generated by the ML module using outputs of the ANN based on the feature vector; and generating at least one score for the at least one entity node based on the plurality of predictive scoring parameters.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings may contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a network diagram of a system for AI-based automated real-time analysis and generation of predictive entity scoring based on entity data consistent with the present disclosure;

FIG. 2 illustrates a network diagram of a system for AI-based automated real-time analysis and generation of predictive entity scoring based on entity data implemented using a blockchain network consistent with the present disclosure;

FIG. 3 illustrates a network diagram of a system including detailed features of a Predictive Scoring Server (PSS) node consistent with the present disclosure;

FIG. 4 illustrates a flowchart of a method for AI-based automated real-time analysis and generation of predictive entity scoring based on entity data consistent with the present disclosure;

FIG. 5 illustrates a further flowchart of a method for AI-based automated real-time analysis and generation of predictive entity scoring based on entity data consistent with the present disclosure;

FIG. 6 illustrates deployment of a machine learning model for prediction of the predictive scoring parameters using blockchain assets consistent with the present disclosure;

FIG. 7 illustrates a block diagram of a system including a computing device for performing the method of FIGS. 4 and 5.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 37 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of the predictive analytics of entity in terms of its credit risk assessment, embodiments of the present disclosure are not limited to use only in this context.

The following definitions may be used in the present disclosure.
“A feature vector” refers to a mathematical representation of the key classifying features, typically in the form of an n-dimensional vector where each dimension corresponds to a specific feature. This vector is used as input for machine learning algorithms to categorize or analyze the entity effectiveness data.
“An entity scoring predictive model” refers to machine learning model trained on historical entity-related data to predict various outcomes or characteristics of an entity risk assessment. This model takes the feature vector as an input and outputs predictions about a set of predictive scoring parameters.
“Predictive scoring parameters” refer to values that may quantify how the system evaluates the lending risk score of an entity or an individual entity.
“Pre-set threshold value” refers to a predetermined numerical value used as a decision boundary for triggering actions within the disclosed system. This value may be set based on historical data, expert knowledge, or specific data processing requirements.

The disclosed embodiments provide for an ecosystem designed to provide consumers with business or individual financial analysis that integrates six processing features. The disclosed system offers real-time analysis of multiple bank account transactions through a six-part scoring system. This system integrates transactional patterns, non-traditional income verification, loan detection, spending behaviors, and predictive modeling. As a result, it generates an adaptive creditworthiness score that accurately reflects current financial capacity instead of relying solely on historical credit data.

In one embodiment, the disclosed system integrates predictive modeling and behavioral analysis into banking risk assessment. The system automatically verifies employment and income by analyzing direct deposit patterns. Additionally, the system can process data from multiple accounts across different banks, providing a comprehensive view of a borrower's financial situation. This enables lenders, banks, and various other businesses that can benefit from the use of the disclosed system to determine suitable loan amounts and payment schedules based on actual cash flow rather than projected income.

The disclosed system is designed to perform a computer-implemented method that scores six independent elements based on a real-time cash flow analysis of consumer or business bank accounts. It can analyze multiple bank accounts owned by the same individual or entity to provide a comprehensive assessment of their financial situation. By utilizing real-time data rather than relying on historical or static credit information, this system offers a more accurate and adaptive evaluation of a borrower's financial stability and their ability to repay a loan.

The system is configured to analyze two years of transactional data from one or more bank accounts. Based on account activity, such as the frequency and amounts of credits and debits, along with predictive modeling, a score is derived to assess the entity's capacity for new debt and the likelihood of loan repayment. In this manner, the system delivers a complete scoring model that includes an in-depth cash flow analysis, helping clients manage payments effectively. Real-time verification of employment and income sources contributes to determining a score based on debts, current bank account and transaction data, non-traditional loans, alternative income sources, spending habits, and behavioral patterns.

This comprehensive approach, advantageously, addresses a critical aspect of technology implementation often overlooked in purely technical solutions.

The present disclosure provides a system, method and computer-readable medium for AI-based real-time automated analysis and generation of predictive entity scoring based on entity data. In one embodiment, the system overcomes the limitations of existing methods of evaluation of entity data by employing fine-tuned models to process the entity-related information, irrespective of data format, style, or data type. By leveraging the capabilities of the predictive models and large language models, the disclosed approach offers a significant improvement over existing solutions discussed above in the background section.

In one embodiment of the present disclosure, the system provides for an AI and machine learning (ML)—generated predictive scoring parameters for generating score for the at least one entity node (e.g., based on acquired entity metrics). In one embodiment, an entity scoring predictive model may be generated to output the predictive scoring parameters. In one embodiment, an entity optimization predictive model may be configured and trained to produce a plurality of entity optimization recommendations.

The entity scoring predictive model may use historical entity-related data collected at the current entity digital platform location (or site) and at other external sites of the same type of entity located within a certain range from the current location or even located globally. The relevant historical entity-related data may include data related to other entities (individuals or enterprises) having the same parameters such as language, age, gender, type of a business, jurisdiction, locations, etc. The relevant historical entity-related data may indicate successfully scored entities based on the previous predictive analytics including predictive scoring parameters and recommendations made by an automated AI-based agent.

In one embodiment, to enhance this process, the system may integrate advanced technologies discussed above, such as Artificial Intelligence (AI) and machine-learning (ML) and Blockchain. The AI may be leveraged for several key functions in the following manner discussed herein.

Additionally, the disclosed entity scoring system may incorporate Blockchain technology to ensure the transparency and immutability of transactions, providing a secure and trustworthy platform. By embedding these advanced technologies, the disclosed system for scoring of the target entity, advantageously, offers a sophisticated and secure solution.

As discussed above, in one disclosed embodiment, the AI/ML technology may be combined with a blockchain technology for secure use of the entity-related data, predictive scoring parameters data and final approved scores. In one embodiment, a blockchain consensus may need to be implemented prior to provision of the final entity scoring predictive model configured to produce a plurality of entity predictive scoring parameters and/or a scoring/optimization report to a lending entity that has initiated a target entity evaluation request.

In one embodiment, entity parameters-related data and entity scoring predictive model along with the predictive scoring parameters and the entity scoring/optimization reports may be stored in a form of uniquely minted NFTs on the private (permissioned) blockchain ledger. In one embodiment, the ML module may use the entity predictive model(s) and the entity optimization predictive model(s) that use an artificial neural network (ANN) to generate the predictive scoring parameters and the entity optimization parameters. The use of specially trained ANNs provides a number of improvements over traditional methods of generation of predictive scoring parameters, including more accurate prediction of these parameters. The application further provides methods for training the ANN that leads to a more accurate predictive model(s).

In one embodiment, the ANN can be implemented by means of computer-executable instructions, hardware, or a combination of the computer-executable instructions and hardware. In one embodiment, neurons of the ANN may be represented by a register, a microprocessor configured to process input signals. Each neuron produces an output, or activation, based on an activation function that uses the outputs of the previous layer and a set of weights as inputs. Each neuron in a neuron array may be connected to another neuron via a synaptic circuit. A synaptic circuit may include a memory for storing a synaptic weight. A proposed ANN may be implemented as a Deep Neural Network having an input layer, an output layer, and several fully connected hidden layers. The proposed ANN may be particularly useful in production of the entity-related parameters because the ANN can effectively extract features from the entity-related profile data in linear and non-linear relationships. In some embodiments, the proposed ANN may be implemented by an application-specific integrated circuit (ASIC). The ASICs may be specially designed and configured for a specific AI application and provide superior computing capabilities and reduced electricity and computational resources consumption compared to the traditional CPUs.

In summary, the embodiments provided herein relate to a system and method for implementing an application configured to offer a dependable and user-friendly approach for assessing the target entity using entity metrics in real-time.

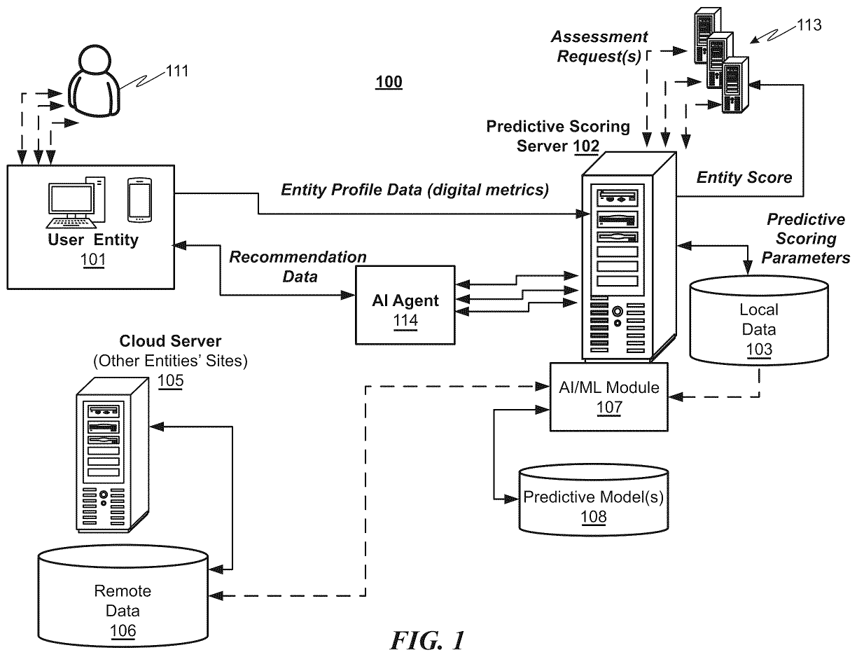

FIG. 1 illustrates a network diagram of a system for AI-based automated real-time analysis and generation of predictive entity scoring based on entity data consistent with the present disclosure.

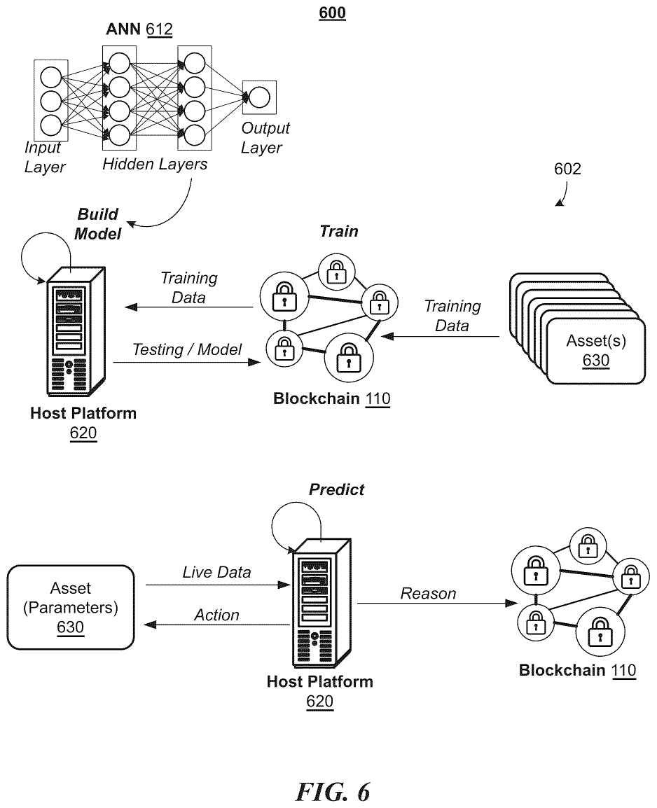

Referring to FIG. 1, the example network 100 includes the Predictive Scoring Server (PSS) node 102 connected to a cloud server node(s) 105 over a network. The PSS node 102 is configured to host an AI/ML module 107 couple to the ANN (shown as 612 in FIG. 6). The PSS node 102 may receive target entity profile data from the user-entity node 101 associated with the user 111 upon an assessment request from a lending or processor entities 113. The target entity profile data may include digital entity 101 metrics from the digital platform nodes. The metrics may include any of: deposits and withdrawals associated with the at least one target entity; transaction patterns across accounts linked to the at least one target entity; deposit frequency and amounts data associated with the at least one target entity; existing non-traditional loans based on payment pattern analysis; spending behaviors and categorizes transactions; and correlation data across bank accounts owned by the at least one target entity.

The PSS node 102 may also receive entity 101-related data from external sources (not shown). The external data may include, but not be limited to live audio/video data; imaging data; textual data; and a combination of these types of data. In one embodiment, the entity 101-related raw data may be processed by the PSS node 102 using the pre-trained large language models (LLMs).

In one embodiment, the PSS node 102 may capture a conversation data (e.g., call, audio or textual data) related to communication between the user entity 101 associated the user 111 and an AI agent 114 that may be implemented as a chatbot supported by the AI/ML module 107 of the PSS node 102. The conversation data may have language identifier metadata representing the language of the user 111 used during the communication with the AI agent 114. In one embodiment, the conversations and recommendations data may be processed by the PSS node 102 using the pre-trained LLMs. In one embodiment, the PSS node 102 may derive the language identifier and parse out the conversation data based on the language identifier metadata. In other words, the key features of the conversation data may be, advantageously, derived from the conversation data based on the language of the call or email, text or other communication.

In one embodiment, the language identifier may serve as a kind of a linguistic profile associated with the user 111. The language identifier may guide the AI/ML module 107 in dynamically tailoring the conversation parameters for the scoring predictive model (e.g., 108). Depending on the language identifier, the PSS node 102 could engage specialized language models or apply unique natural language processing techniques optimized for that language.

Regarding the global reach of the disclosed system and method, a cultural intelligence layer may be added to the application based on the language identifier. The goal of this layer is for the system to not only recognize the language, but also adapt its recommendations and interactions to be culturally sensitive and appropriate for the user 111 of the user-entity 101. In one embodiment, the disclosed system may employ integrated translation capabilities. This may allow both the user 111 to communicate effortlessly via the chatbot (i.e., the AI agent 114), no matter where they are in the world or what languages they use. The language identifier metadata may support and/or trigger this feature, making the system truly globally effective.

The PSS node 102 may query a local database 103 to retrieve local historical entity-related data based on the plurality of the entity features. The PSS node 102 may acquire relevant remote historical entity-related data and the entity optimization data in a form of previous scores from a remote database 106 residing on the cloud server 105. The remote historical entity-related data in the database 106 may be collected from other sites and/or digital platform nodes associated with similar entities (i.e., same jurisdiction, language, size, type of ownership and business, revenue, existing loans, etc.) based in part on entity 101 parameters.

The PSS node 102 may generate a feature vector or classifier data based on the entity profile data and the collected heuristics data (i.e., pre-stored local historical entity-related data 103 and the remote historical entity-related data 106). The PSS node 102 may ingest the feature vector/classifier data into an AI/ML module 107. The AI/ML module 107 may generate a predictive model(s) 108 based on the feature vector/classifier data to ultimately predict entity 101 scoring parameters. The entity 101 scoring parameters may be further analyzed by the PSS node 102 prior to generation of the actual score or recommendations (or scoring reports). Once the user entity's 101 data is fully processed through the AI/ML module 107, the entire scoring and recommendations'data may be analyzed to generate a feedback report by the AI/ML module 107 based on the outputs of the predictive models 108 (e.g., the entity scoring predictive model and/or the entity optimization predictive model).

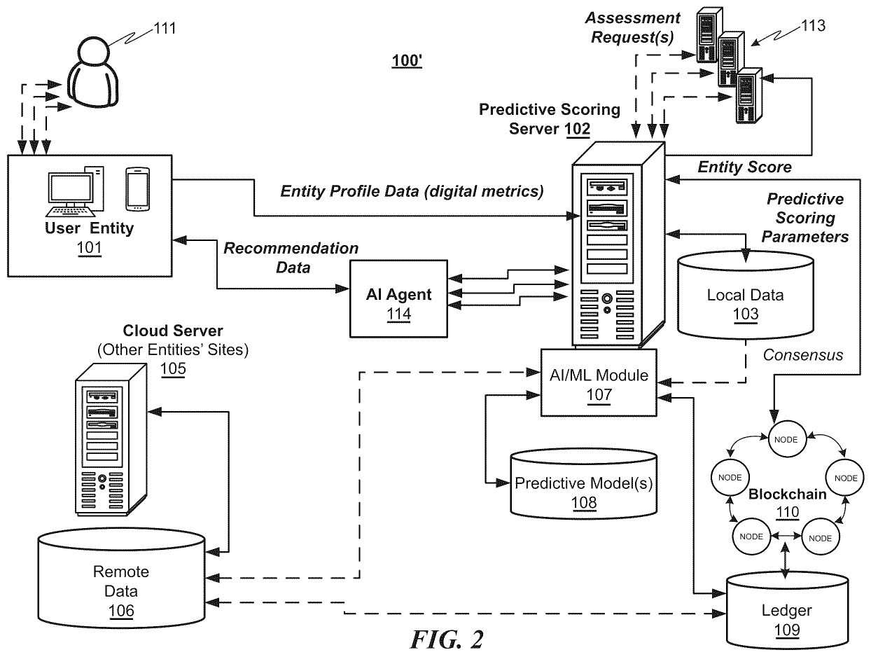

FIG. 2 illustrates a network diagram of a system for AI-based automated real-time analysis and generation of predictive entity scoring based on entity data implemented using a blockchain network consistent with the present disclosure.

Referring to FIG. 2, the example network 100′ includes the Predictive Scoring Server (PSS) node 102 connected to a cloud server node(s) 105 over a network. The PSS node 102 is configured to host an AI/ML module 107 couple to the ANN (shown as 612 in FIG. 6). The PSS node 102 may receive target entity profile data from the user-entity node 101 associated with the user 111 upon an assessment request from a lending or processor entities 113. As discussed above, the target entity profile data may include digital entity 101 metrics from the digital platform nodes. The metrics may include any of: deposits and withdrawals associated with the at least one target entity; transaction patterns across accounts linked to the at least one target entity; deposit frequency and amounts data associated with the at least one target entity; existing non-traditional loans based on payment pattern analysis; spending behaviors and categorizes transactions; and correlation data across bank accounts owned by the at least one target entity.

The PSS node 102 may also receive entity 101-related data from external sources (not shown). The external data may include, but not be limited to live audio/video data; imaging data; textual data; and a combination of these types of data. In one embodiment, the entity 101-related raw data may be processed by the PSS node 102 using the pre-trained large language models (LLMs).

In one embodiment, the PSS node 102 may capture a conversation data (e.g., call, audio or textual data) related to communication between the user entity 101 associated the user 111 and an AI agent 114 that may be implemented as a chatbot supported by the AI/ML module 107 of the PSS node 102. The conversation data may have language identifier metadata representing the language of the user 111 used during the communication with the AI agent 114.

The PSS node 102 may query a local database 103 to retrieve local historical entity-related data based on the plurality of the entity features. The PSS node 102 may acquire relevant remote historical entity-related data and the entity optimization data in a form of previous scores from a remote database 106 residing on the cloud server 105. The remote historical entity-related data in the database 106 may be collected from other sites and/or digital platform nodes associated with similar entities (i.e., same jurisdiction, language, size, type of ownership and business, revenue, existing loans, etc.) based in part on entity 101 parameters.

The PSS node 102 may generate a feature vector or classifier data based on the entity profile data and the collected heuristics data (i.e., pre-stored local historical entity-related data 103 and the remote historical entity-related data 106). The PSS node 102 may ingest the feature vector/classifier data into an AI/ML module 107. The AI/ML module 107 may generate a predictive model(s) 108 based on the feature vector/classifier data to ultimately predict entity 101 scoring parameters. The entity 101 scoring parameters may be further analyzed by the PSS node 102 prior to generation of the actual score or recommendations (or scoring reports). Once the user entity's 101 data is fully processed through the AI/ML module 107, the entire scoring and recommendations'data may be analyzed to generate a feedback report by the AI/ML module 107 based on the outputs of the predictive models 108 (e.g., the entity scoring predictive model and/or the entity optimization predictive model).

In one embodiment, the PSS node 102 may receive the entity 101 profile data for scoring of the entity 101 from a permissioned blockchain 110 ledger 109 based on a consensus from the user entity nodes 101, lending/processing entities 113 nodes along with the PSS node 102. Additionally, confidential historical entity-related information and previous entities-related data and data related to the entity scoring parameters may also be acquired from the permissioned blockchain 110. The newly acquired entity profile data with corresponding predicted entity scoring parameters data may be also recorded on the ledger 109 of the blockchain 110 so it can be used as training data for the predictive model(s) 108.

In this implementation the PSS node 102, the cloud server 105, the user entities(s) 101 and entity nodes 113 may serve as blockchain 110 peer nodes. In one embodiment, local data from the database 103 and remote data from the database 106 may be duplicated on the blockchain ledger 109 for higher security of storage.

The AI/ML module 107 may generate the entity scoring predictive models(s) and the entity optimization predictive model(s) 108 to generate the predictive scoring parameters for the given target entity 101 risk assessment evaluation and scoring in response to the specific relevant pre-stored data acquired from the blockchain 110 ledger 109. This way, the current entity 101 data and scoring parameters may be predicted based not only on the current user entity 101-related data (i.e., entity metrics), but also based on the previously collected heuristics. Thus, the scoring verdict and/or report of the entity 101 may be recorded. After the entity 101 evaluation and scoring data processing and report generation is completed, the related documents may be converted into unique secure NFT assets to be recorded on the blockchain 110 to be used for future entity scoring predictive models(s) training.

In one embodiment, as a second round of approval, a blockchain consensus may be achieved among the user entities 101 and entities 113 in order to approve the entity 101 scoring/assessment report generated by the PSS node 102.

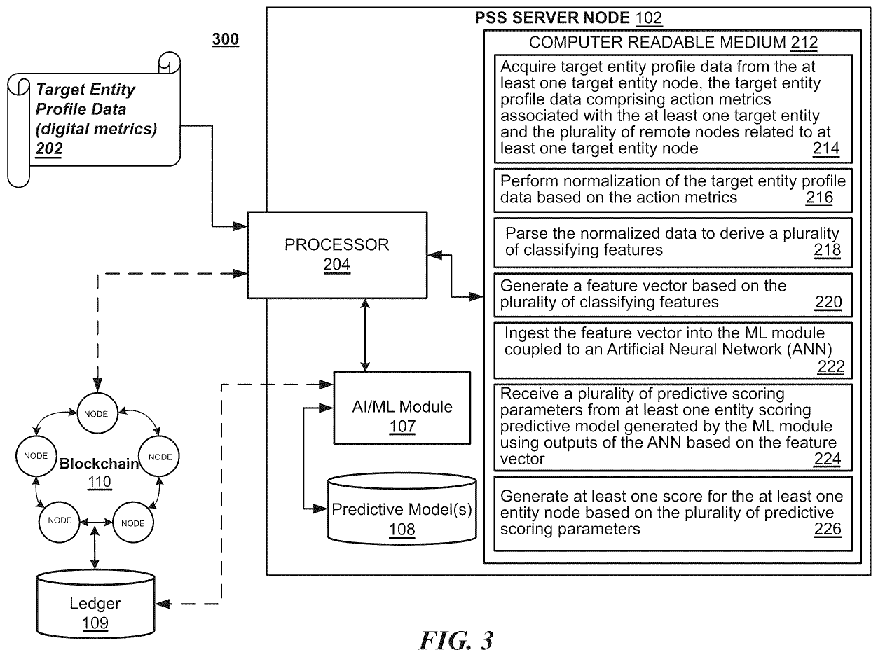

FIG. 3 illustrates a network diagram of a system including detailed features of a Predictive Scoring Server (PSS) node consistent with the present disclosure.

Referring to FIG. 3, the example network 300 includes the PSS node 102 connected to the user entity 101 node(s) (see FIGS. 1-2) to receive target entity profile data 202 including target entity metrics data discussed above.

The PSS node 102 is configured to host an AI/ML module 107. As discussed above with respect to FIGS. 1-2, the PSS node 102 may receive the target entity profile data 202 including current target entity metrics and pre-stored entity-related data and previous entities'-related data retrieved from the local and remote databases. As discussed above, the pre-stored entity-related data and scoring-related data may be retrieved from the ledger 109 of the permissioned blockchain 110.

The AI/ML module 107 may generate the entity scoring predictive model(s) 108 based on the received data 202 provided by the PSS node 102. As discussed above, the AI/ML module 107 may provide predictive outputs data in the form of predictive scoring parameters and optionally optimization parameters for a given target entity for automated generation of scores(s) and risk assessments. The PSS node 102 may process the predictive outputs data received from the AI/ML module 107 to generate the entity scores and scoring reports.

In one embodiment, the PSS node 102 may continually monitor the incoming entity profile data and may detect a parameter that deviates from a previous recorded parameter (or from a median reading value) by a margin that exceeds a threshold value pre-set for this particular parameter. For example, if the entity-related data (i.e., entity metrics) change significantly (e.g., loan paid off or income increases), this may cause a change in the predictive scoring parameters produced by the PSS node 102. Accordingly, once the threshold is met or exceeded by at least one parameter of the user entity 101, the PSS node 102 may provide the currently acquired entity metrics to the AI/ML module 107 to generate updated predictive scoring parameters based on the current entity 101-related data (i.e., the entity metrics).

While this example describes in detail only one PSS node 102, multiple such nodes may be connected to the network and to the blockchain 110. It should be understood that the PSS node 102 may include additional components and that some of the components described herein may be removed and/or modified without departing from a scope of the PSS node 102 disclosed herein. The PSS node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the PSS node 102 may include multiple processors, multiple cores, or the like, without departing from the scope of the PSS node 102 system.

The RS node 102 may also include a non-transitory computer readable medium 212 that may have stored thereon machine-readable instructions executable by the processor 204. Examples of the machine-readable instructions are shown as 214-226 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to acquire target entity profile data from the at least one target entity node 101, the target entity profile data comprising action metrics associated with the at least one target entity and the plurality of remote nodes related to the at least one target entity node 101 (FIGS. 1-2). The processor 204 may fetch, decode, and execute the machine-readable instructions 216 to perform normalization of the target entity profile data based on the action metrics. The processor 204 may fetch, decode, and execute the machine-readable instructions 218 to parse the normalized data to derive a plurality of classifying features. The processor 204 may fetch, decode, and execute the machine-readable instructions 220 to generate a feature vector based on the plurality of classifying features.

The processor 204 may fetch, decode, and execute the machine-readable instructions 222 to ingest the feature vector into the ML module 107 coupled to an Artificial Neural Network (ANN). The processor 204 may fetch, decode, and execute the machine-readable instructions 224 to receive a plurality of predictive scoring parameters from at least one entity scoring predictive model generated by the ML module 107 using outputs of the ANN based on the feature vector.

The processor 204 may fetch, decode, and execute the machine-readable instructions 226 to generate at least one score for the at least one entity node 101 based on the plurality of predictive scoring parameters.

As a non-limiting example, the consensual approval of the predictive scoring parameters may be associated with a request implemented via the AI agent 114 for additional data such as additional entity metrics, etc. The permissioned blockchain 110 may be configured to use one or more smart contracts that manage transactions for multiple participating nodes and for recording the transactions on the ledger 109.

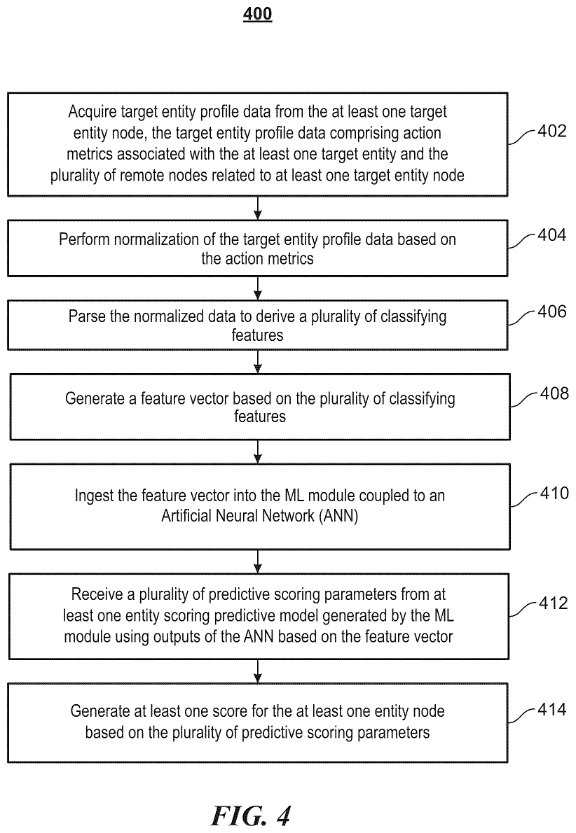

FIG. 4 illustrates a flowchart of a method for AI-based automated real-time analysis and generation of predictive entity scoring based on entity data consistent with the present disclosure.

Referring to FIG. 4, the method 400 may include one or more of the steps described below. FIG. 4 illustrates a flow chart of an example method executed by the PSS node 102 (see FIG. 3). It should be understood that method 400 depicted in FIG. 4 may include additional operations and that some of the operations described therein may be removed and/or modified without departing from the scope of the method 400. The description of the method 400 is also made with reference to the features depicted in FIG. 3 for purposes of illustration. Particularly, the processor 204 of the PSS node 102 may execute some or all of the operations included in the method 400.

With reference to FIG. 4, at block 402, the processor 204 may acquire target entity profile data from the at least one target entity node, the target entity profile data comprising action metrics associated with the at least one target entity and the plurality of remote nodes related to at least one target entity node. At block 404, the processor 204 may perform normalization of the target entity profile data based on the action metrics.

At block 406, the processor 204 may parse the normalized data to derive a plurality of classifying features. At block 408, the processor 204 may generate a feature vector based on the plurality of classifying features. At block 410, the processor 204 may ingest the feature vector into the ML module coupled to an Artificial Neural Network (ANN). At block 412, the processor 204 may receive a plurality of predictive scoring parameters from at least one entity scoring predictive model generated by the ML module using outputs of the ANN based on the feature vector. At block 414, the processor 204 may generate at least one score for the at least one entity node based on the plurality of predictive scoring parameters.

The metrics may be any of: deposits and withdrawals associated with the at least one target entity; transaction patterns across accounts linked to the at least one target entity; deposit frequency and amounts data associated with the at least one target entity; existing non-traditional loans based on payment pattern analysis; spending behaviors and categorizes transactions; and correlation data across bank accounts owned by the at least one target entity.

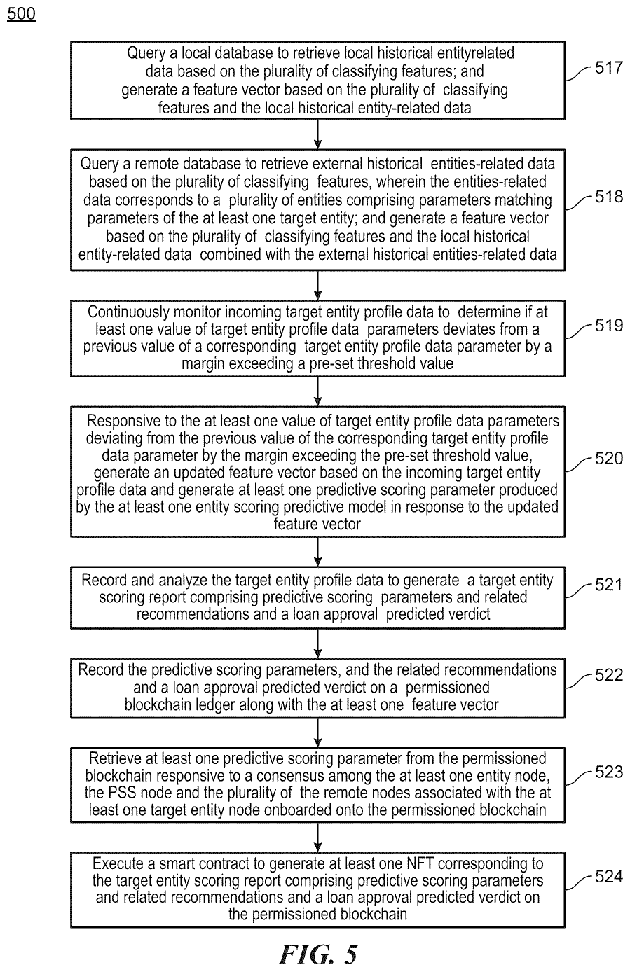

FIG. 5 illustrates a further flowchart of a method for AI-based automated real-time analysis and generation of predictive entity scoring based on entity data consistent with the present disclosure.

Referring to FIG. 5, the method 500 may include one or more of the steps described below. FIG. 5 illustrates a flow chart of an example method executed by the PSS node 102 (see FIG. 3). It should be understood that method 500 depicted in FIG. 5 may include additional operations and that some of the operations described therein may be removed and/or modified without departing from the scope of the method 500. The description of the method 500 is also made with reference to the features depicted in FIG. 3 for purposes of illustration. Particularly, the processor 204 of the PSS 102 may execute some or all of the operations included in the method 500.

With reference to FIG. 5, at block 517, the processor 204 query a local database to retrieve local historical entity-related data based on the plurality of classifying features; and generate a feature vector based on the plurality of classifying features and the local historical entity-related data. At block 518, the processor 204 may query a remote database to retrieve external historical entities-related data based on the plurality of classifying features, wherein the entities-related data corresponds to a plurality of entities comprising parameters matching parameters of the at least one target entity; and generate a feature vector based on the plurality of classifying features and the local historical entity-related data combined with the external historical entities-related data.

At block 519, the processor 204 may continuously monitor incoming target entity profile data to determine if at least one value of target entity profile data parameters deviates from a previous value of a corresponding target entity profile data parameter by a margin exceeding a pre-set threshold value. At block 520, the processor 204 may responsive to the at least one value of target entity profile data parameters deviating from the previous value of the corresponding target entity profile data parameter by the margin exceeding the pre-set threshold value, generate an updated feature vector based on the incoming target entity profile data and generate at least one predictive scoring parameter produced by the at least one entity scoring predictive model in response to the updated feature vector.

At block 521, the processor 204 may record and analyze the target entity profile data to generate a target entity scoring report comprising predictive scoring parameters and related recommendations and a loan approval predicted verdict.

At block 522, the processor 204 may record the predictive scoring parameters, and the related recommendations and a loan approval predicted verdict on a permissioned blockchain ledger along with the at least one feature vector. At block 523, the processor 204 may retrieve at least one predictive scoring parameter from the permissioned blockchain responsive to a consensus among the at least one entity node, the PSS node and the plurality of the remote nodes associated with the at least one target entity node onboarded onto the permissioned blockchain.

At block 524, the processor 204 may execute a smart contract to generate at least one NFT corresponding to the target entity scoring report comprising predictive scoring parameters and related recommendations and a loan approval predicted verdict on the permissioned blockchain.

In one disclosed embodiment, the entity scoring predictive model may be generated by the AI/ML module 107 that may use training data sets to improve accuracy of the prediction of the predictive scoring parameters. The predictive scoring parameters and/or the optimization parameters used in training data sets may be stored in a centralized local database (such as one used for storing local historical entity-related data 103 depicted in FIG. 1). In one embodiment, the ANN 612 (FIG. 6) may be used in the AI/ML module 107 for the scoring parameters and/or the optimization parameters modeling and report(s) generation.

In another embodiment, the AI/ML module 107 may use a decentralized storage such as a blockchain 110 (see FIG. 2) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records and no single peer can modify the records without a consensus being reached among the distributed peers. For example, the peers 101, 105, 113 and 102 (FIG. 2) may execute a consensus protocol to validate blockchain 110 storage transactions, group the storage transactions into blocks, and build a hash chain over the blocks. This process forms the ledger 109 by ordering the storage transactions, as is necessary, for consistency. In various embodiments, a permissioned and/or a permissionless blockchain can be used. In a public or permissionless blockchain, anyone can participate without a specific identity. Public blockchains can involve assets and use consensus based on various protocols such as Proof of Work (PoW). On the other hand, a permissioned blockchain provides secure interactions among a group of entities which share a common goal, but which do not fully trust one another.

This application utilizes a permissioned (private) blockchain that operates arbitrary, programmable logic, tailored to a decentralized storage scheme and referred to as “smart contracts” or “chaincodes.”

The permissioned blockchain is a type of blockchain network where participation is restricted to authorized entities. In the PSS node 102, the smart contracts may be used to automate the recording of the scoring parameters and/or the optimization parameters, updates of the entity metrics, or generation of NFTs (Non-Fungible Tokens) that are unique digital assets on the blockchain representing ownership or proof of authenticity of a specific item(s). In the PSS node 102 context, an NFT represents unique scoring parameters and/or the optimization parameters, providing a tamper-proof record of the entity-related scorings parameters and evaluation.

In some cases, specialized chaincodes may exist on blockchain for management functions and parameters which are referred to as system chaincodes. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After a validation, the transactions enter an ordering phase in which a consensus protocol is used to produce an ordered sequence of endorsed transactions grouped into blocks.

In the example 600 depicted in FIG. 6, a host platform 620 (such as the PSS node 102) builds and deploys a machine learning model for predictive monitoring of assets 630. Here, the host platform 620 may be a cloud platform, an industrial server, a web server, a personal computer, a user device, and the like. Assets 630 can represent the entity scorings and optimization parameters. The blockchain 110 can be used to significantly improve both a training process 602 of the machine learning model and the scoring parameters'predictive process 607 based on a trained machine learning model that uses outputs of the ANN 612. For example, in 602, rather than requiring a data scientist/engineer or other user to collect the data, historical data (heuristics—i.e., entity-related data) may be stored by the assets 630 themselves (or through an intermediary, not shown) on the blockchain 110.

This can significantly reduce the collection time needed by the host platform 620 when performing predictive model training. For example, using smart contracts, data can be directly and reliably transferred straight from its place of origin (e.g., from the PSS node 102 or from the databases 103 and 106 depicted in FIGS. 1-2) to the blockchain 110. By using the blockchain 110 to ensure the security and ownership of the collected data, smart contracts may directly send the data from the assets to the entities that use the data for building a machine learning model. This allows for sharing of data among the assets 630. The collected data may be stored in the blockchain 110 based on a consensus mechanism. The consensus mechanism pulls in (permissioned nodes) to ensure that the data being recorded is verified and accurate. The data recorded is time-stamped, cryptographically signed, and immutable. It is therefore auditable, transparent, and secure.

Furthermore, training of the machine learning model on the collected data may take rounds of refinement and designing by the host platform 620. Each round may be based on additional data or data that was not previously considered to help expand the knowledge of the machine learning model. In 602, the different training and designing steps (and the data associated therewith) may be stored on the blockchain 110 by the host platform 620. Each refinement of the machine learning model (e.g., changes in variables, weights, etc.) may be stored on the blockchain 110. This, advantageously, provides verifiable proof of how the model was trained and what data was used to train the model. Furthermore, when the host platform 620 has achieved a finally trained model, the resulting model itself may be stored on the blockchain 110.

After the model has been trained, it may be deployed to a live environment where it can make recommendation-related predictions/decisions based on the execution of the final trained machine learning model using the predictive parameters. In this example, data fed back from the asset 630 may be input into the machine learning model and may be used to make predictions such as the predictive scoring parameters based on the recorded entity-related data. Determinations made by the execution of the machine learning model (e.g., approval of predictive scoring parameters and evaluation reports, etc.) at the host platform 620 may be stored on the blockchain 110 to provide auditable/verifiable proof. As one non-limiting example, the machine learning model may predict a future change of a part of the asset 630 (the predictive scoring parameters—i.e., evaluation of the digital entity metrics). The data behind this decision may be stored by the host platform 620 on the blockchain 110.

As discussed above, in one embodiment, the features and/or the actions described and/or depicted herein can occur on or with respect to the blockchain 110. The above embodiments of the present disclosure may be implemented in hardware, in computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

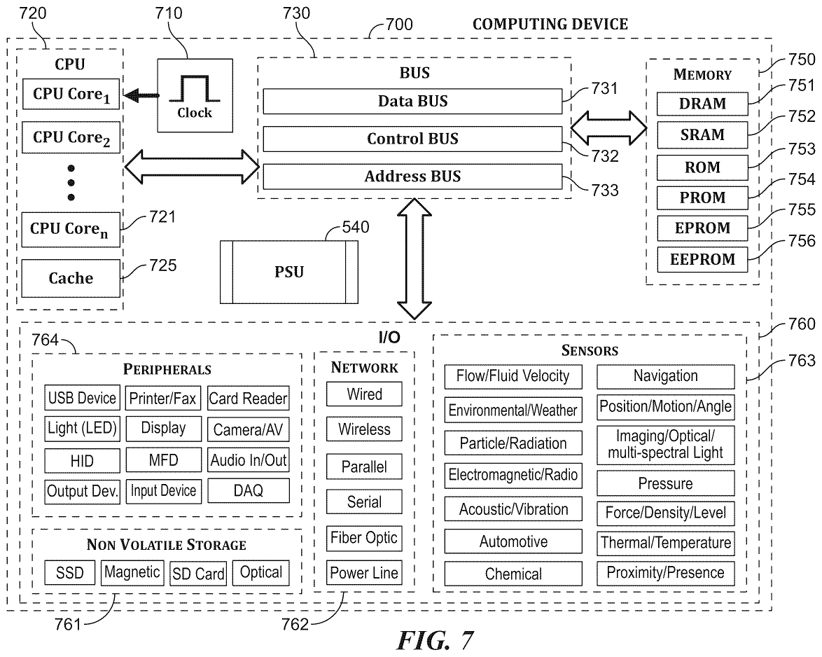

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 7 illustrates an example computing device (e.g., a server node) 700, which may represent or be integrated in any of the above-described components, etc.

FIG. 7 illustrates a block diagram of a system including computing device 700. The computing device 700 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS700/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;
The PSS node 102 (see FIG. 3) may be hosted on a centralized server or on a cloud computing service. Although method 400 has been described to be performed by the PSS node 102 implemented on a computing device 700, it should be understood that, in some embodiments, different operations may be performed by a plurality of the computing devices 700 in operative communication at least one network.

Embodiments of the present disclosure may comprise a computing device having a central processing unit (CPU) 720, a bus 730, a memory unit 770, a power supply unit (PSU) 770, and one or more Input/Output (I/O) units. The CPU 720 coupled to the memory unit 770 and the plurality of I/O units 760 via the bus 730, all of which are powered by the PSU 770. It should be understood that, in some embodiments, each disclosed unit may actually be a plurality of such units for the purposes of redundancy, high availability, and/or performance. The combination of the presently disclosed units is configured to perform the stages of any method disclosed herein.

Consistent with an embodiment of the disclosure, the aforementioned CPU 720, the bus 730, the memory unit 770, a PSU 770, and the plurality of I/O units 760 may be implemented in a computing device, such as computing device 700. Any suitable combination of hardware, software, or firmware may be used to implement the aforementioned units. For example, the CPU 720, the bus 730, and the memory unit 770 may be implemented with computing device 700 or any of other computing devices 700, in combination with computing device 700. The aforementioned system, device, and components are examples and other systems, devices, and components may comprise the aforementioned CPU 720, the bus 730, the memory unit 770, consistent with embodiments of the disclosure.

At least one computing device 700 may be embodied as any of the computing elements illustrated in all of the attached figures, including the PSS node 102 (FIG. 3). A computing device 700 does not need to be electronic, nor even have a CPU 720, nor bus 730, nor memory unit 770. The definition of the computing device 700 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 700, especially if the processing is purposeful.

With reference to FIG. 7, a system consistent with an embodiment of the disclosure may include a computing device, such as computing device 700. In a basic configuration, computing device 700 may include at least one clock module 710, at least one CPU 720, at least one bus 730, and at least one memory unit 770, at least one PSU 770, and at least one I/O 760 module, wherein I/O module may be comprised of, but not limited to a non-volatile storage sub-module 761, a communication sub-module 762, a sensors sub-module 763, and a peripherals sub-module 767.

A system consistent with an embodiment of the disclosure the computing device 700 may include the clock module 710 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 720, the central component of modern computers, which relies on a clock. The only exceptions are asynchronous circuits such as asynchronous CPUs. The clock 710 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 7 wires.

Many computing devices 700 use a “clock multiplier” which multiplies a lower frequency external clock to the appropriate clock rate of the CPU 720. This allows the CPU 720 to operate at a much higher frequency than the rest of the computer, which affords performance gains in situations where the CPU 720 does not need to wait on an external factor (like memory 770 or input/output 760). Some embodiments of the clock 710 may include dynamic frequency change, where the time between clock edges can vary widely from one edge to the next and back again.

A system consistent with an embodiment of the disclosure the computing device 700 may include the CPU unit 720 comprising at least one CPU Core 721. A plurality of CPU cores 721 may comprise identical CPU cores 721, such as, but not limited to, homogeneous multi-core systems. It is also possible for the plurality of CPU cores 721 to comprise different CPU cores 721, such as, but not limited to, heterogeneous multi-core systems, big. LITTLE systems and some AMD accelerated processing units (APU). The CPU unit 720 reads and executes program instructions which may be used across many application domains, for example, but not limited to, general purpose computing, embedded computing, network computing, digital signal processing (DSP), and graphics processing (GPU). The CPU unit 720 may run multiple instructions on separate CPU cores 721 at the same time. The CPU unit 720 may be integrated into at least one of a single integrated circuit die and multiple dies in a single chip package. The single integrated circuit die and multiple dies in a single chip package may contain a plurality of other aspects of the computing device 700, for example, but not limited to, the clock 710, the CPU 720, the bus 730, the memory 770, and I/O 760.

The CPU unit 720 may contain cache 722 such as, but not limited to, a level 1 cache, level 2 cache, level 3 cache or combination thereof. The aforementioned cache 722 may or may not be shared amongst a plurality of CPU cores 721. The cache 722 sharing comprises at least one of message passing and inter-core communication methods may be used for the at least one CPU Core 721 to communicate with the cache 722. The inter-core communication methods may comprise, but not limited to, bus, ring, two-dimensional mesh, and crossbar. The aforementioned CPU unit 720 may employ symmetric multiprocessing (SMP) design.

The plurality of the aforementioned CPU cores 721 may comprise soft microprocessor cores on a single field programmable gate array (FPGA), such as semiconductor intellectual property cores (IP Core). The plurality of CPU cores 721 may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 721, for example, but not limited to Instruction-level parallelism (ILP) such as, but not limited to, superscalar pipelining, and Thread-level parallelism (TLP).

Consistent with the embodiments of the present disclosure, the aforementioned computing device 700 may employ a communication system that transfers data between components inside the aforementioned computing device 700, and/or the plurality of computing devices 700. The aforementioned communication system will be known to a person having ordinary skill in the art as a bus 730. The bus 730 may embody internal and/or external plurality of hardware and software components, for example, but not limited to a wire, optical fiber, communication protocols, and any physical arrangement that provides the same logical function as a parallel electrical bus. The bus 730 may comprise at least one of, but not limited to a parallel bus, wherein the parallel bus carry data words in parallel on multiple wires, and a serial bus, wherein the serial bus carry data in bit-serial form. The bus 730 may embody a plurality of topologies, for example, but not limited to, a multidrop/electrical parallel topology, a daisy chain topology, and a connected by switched hubs, such as USB bus. The bus 730 may comprise a plurality of embodiments, for example, but not limited to:
Internal data bus (data bus) 731/Memory bus
Control bus 732
Address bus 733
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/107 bus (e.g., PC/107-Plus, PCI/107-Express, PCI/107, and PCI-107), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1397 Interface/Firewire, Thunderbolt, and extensible Host Controller Interface (xHCI).

Consistent with the embodiments of the present disclosure, the aforementioned computing device 700 may employ hardware integrated circuits that store information for immediate use in the computing device 700, known to the person having ordinary skill in the art as primary storage or memory 770. The memory 770 operates at high speed, distinguishing it from the non-volatile storage sub-module 761, which may be referred to as secondary or tertiary storage, which provides slow-to-access information but offers higher capacities at lower cost. The contents contained in memory 770, may be transferred to secondary storage via techniques such as, but not limited to, virtual memory and swap. The memory 770 may be associated with addressable semiconductor memory, such as integrated circuits consisting of silicon-based transistors, used for example as primary storage but also other purposes in the computing device 700. The memory 770 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 771, Static Random-Access Memory (SRAM) 772, CPU Cache memory 727, Advanced Random-Access Memory (A-RAM), and other types of primary storage such as Random-Access Memory (RAM).
Non-volatile memory which can retain stored information even after power is removed, for example, but not limited to, Read-Only Memory (ROM) 773, Programmable ROM (PROM) 777, Erasable PROM (EPROM) 777, Electrically Erasable PROM (EEPROM) 776 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 700 may employ the communication system between an information processing system, such as the computing device 700, and the outside world, for example, but not limited to, human, environment, and another computing device 700. The aforementioned communication system will be known to a person having ordinary skill in the art as I/O 760. The I/O module 760 regulates a plurality of inputs and outputs with regard to the computing device 700, wherein the inputs are a plurality of signals and data received by the computing device 700, and the outputs are the plurality of signals and data sent from the computing device 700. The I/O module 760 interfaces a plurality of hardware, such as, but not limited to, non-volatile storage 761, communication devices 762, sensors 763, and peripherals 767. The plurality of hardware is used by at least one of, but not limited to, human, environment, and another computing device 700 to communicate with the present computing device 700. The I/O module 760 may comprise a plurality of forms, for example, but not limited to channel I/O, port mapped I/O, asynchronous I/O, and Direct Memory Access (DMA).
Consistent with the embodiments of the present disclosure, the aforementioned computing device 700 may employ the non-volatile storage sub-module 761, which may be referred to by a person having ordinary skill in the art as one of secondary storage, external memory, tertiary storage, off-line storage, and auxiliary storage. The non-volatile storage sub-module 761 may not be accessed directly by the CPU 720 without using an intermediate area in the memory 770. The non-volatile storage sub-module 761 does not lose data when power is removed and may be two orders of magnitude less costly than storage used in memory modules, at the expense of speed and latency. The non-volatile storage sub-module 761 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (761) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 700 may employ the communication sub-module 762 as a subset of the I/O 760, which may be referred to by a person having ordinary skill in the art as at least one of, but not limited to, computer network, data network, and network. The network allows computing devices 700 to exchange data using connections, which may be known to a person having ordinary skill in the art as data links, between network nodes. The nodes comprise network computer devices 700 that originate, route, and terminate data. The nodes are identified by network addresses and can include a plurality of hosts consistent with the embodiments of a computing device 700. The aforementioned embodiments include, but not limited to personal computers, phones, servers, drones, and networking devices such as, but not limited to, hubs, switches, routers, modems, and firewalls.

Two nodes can be networked together, when one computing device 700 is able to exchange information with the other computing device 700, whether or not they have a direct connection with each other. The communication sub-module 762 supports a plurality of applications and services, such as, but not limited to World Wide Web (WWW), digital video and audio, shared use of application and storage computing devices 700, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 7 [IPv7], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 762 may comprise a plurality of size, topology, traffic control mechanism and organizational intent. The communication sub-module 762 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Cellular systems embody technologies such as, but not limited to, 3G,7G (such as WiMax and LTE), and 7G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), entity private network, Virtual Private Network (VPN), and Global Area Network (GAN).

Consistent with the embodiments of the present disclosure, the aforementioned computing device 700 may employ the sensors sub-module 763 as a subset of the I/O 760. The sensors sub-module 763 comprises at least one of the devices, modules, and subsystems whose purpose is to detect events or changes in its environment and send the information to the computing device 700. Sensors are sensitive to the measured property, are not sensitive to any property not measured, but may be encountered in its application, and do not significantly influence the measured property. The sensors sub-module 763 may comprise a plurality of digital devices and analog devices, wherein if an analog device is used, an Analog to Digital (A-to-D) converter must be employed to interface the said device with the computing device 700. The sensors may be subject to a plurality of deviations that limit sensor accuracy. The sensors sub-module 763 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermos-luminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photo-switch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezo capacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 700 may employ the peripherals sub-module 762 as a subset of the I/O 760. The peripheral sub-module 767 comprises ancillary devices used to put information into and get information out of the computing device 700. There are 3 categories of devices comprising the peripheral sub-module 767, which exist based on their relationship with the computing device 700, input devices, output devices, and input/output devices. Input devices send at least one of data and instructions to the computing device 700. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 700. Output devices convert electronically generated information into a form that can be presented to humans. Input/output devices that perform both input and output functions. It should be understood by a person having ordinary skill in the art that the ensuing are non-limiting embodiments of the aforementioned peripheral sub-module 767:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 700. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 700 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrument Digital Interface (MIDI) devices such as, but not limited to a keyboard, and headset.
Data Acquisition (DAQ) devices convert at least one of analog signals and physical parameters to digital values for processing by the computing device 700. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 762 sub-module), data storage device (non-volatile storage 761), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A system for an automated real-time analysis and generation of predictive entity scoring based on entity data, comprising:
a processor of a predictive scoring server (PSS) node configured to host a machine learning (ML) module coupled to at least one target user-entity node and to a plurality of remote nodes associated with the at least one target entity node over a network; and
a memory on which are stored machine-readable instructions that when executed by the processor, cause the processor to:
acquire target entity profile data from the at least one target entity node, the target entity profile data comprising action metrics associated with the at least one target entity and the plurality of remote nodes related to at least one target entity node;
perform normalization of the target entity profile data based on the action metrics;
parse the normalized data and deriving a plurality of classifying features;
generate a feature vector based on the plurality of classifying features;
ingest the feature vector into the ML module coupled to an Artificial Neural Network (ANN);
receive a plurality of predictive scoring parameters from at least one entity scoring predictive model generated by the ML module using outputs of the ANN based on the feature vector;
generate at least one score for the at least one entity node based on the plurality of predictive scoring parameters;
record the predictive scoring parameters, and the related recommendations and a loan approval predicted verdict on a permissioned blockchain ledger along with the at least one feature vector;
retrieve at least one predictive scoring parameter from the permissioned blockchain responsive to a consensus among the at least one entity node, the PSS node and the plurality of the remote nodes associated with the at least one target entity node onboarded onto the permissioned blockchain; and
execute a smart contract and generating at least one NFT corresponding to the target entity scoring report comprising predictive scoring parameters and related recommendations and a loan approval predicted verdict on the permissioned blockchain.

2. The system of claim 1, wherein the action metrics comprising any of:
deposits and withdrawals associated with the at least one target entity;
transaction patterns across accounts linked to the at least one target entity; deposit frequency and amounts data associated with the at least one target
entity;
existing non-traditional loans based on payment pattern analysis; spending behaviors and categorizes transactions; and
correlation data across bank accounts owned by the at least one target entity.

3. The system of claim 1, wherein the machine-readable instructions that when executed by the processor, cause the processor to:
query a local database to retrieve local historical entity-related data based on the plurality of classifying features; and
generate a feature vector based on the plurality of classifying features and the local historical entity-related data.

4. The system of claim 2, wherein the machine-readable instructions that when executed by the processor, cause the processor to:
query a remote database to retrieve external historical entities-related data based on the plurality of classifying features, wherein the entities-related data corresponds to a plurality of entities comprising parameters matching parameters of the at least one target entity; and
generate a feature vector based on the plurality of classifying features and the local historical entity-related data combined with the external historical entities-related data.

5. The system of claim 1, wherein the machine-readable instructions that when executed by the processor, cause the processor to continuously monitor incoming target entity profile data to determine if at least one value of target entity profile data parameters deviates from a previous value of a corresponding target entity profile data parameter by a margin exceeding a pre-set threshold value.

6. The system of claim 5, wherein the machine-readable instructions that when executed by the processor, cause the processor to, responsive to the at least one value of target entity profile data parameters deviating from the previous value of the corresponding target entity profile data parameter by the margin exceeding the pre-set threshold value, generate an updated feature vector based on the incoming target entity profile data and generate at least one predictive scoring parameter produced by the at least one entity scoring predictive model in response to the updated feature vector.

7. The system of claim 1, wherein the machine-readable instructions that when executed by the processor, further cause the processor to record and analyze the target entity profile data to generate a target entity scoring report comprising predictive scoring parameters and related recommendations and a loan approval predicted verdict.

8. (canceled)

9. (canceled)

10. (canceled)

11. A method for an automated real-time analysis and generation of predictive entity scoring based on entity data, comprising:
acquiring, by a predictive scoring server (PSS) node configured to host a machine learning (ML) module, target entity profile data from the at least one target entity node, the target entity profile data comprising action metrics associated with the at least one target entity and the plurality of remote nodes related to at least one target entity node;
performing, by the PSS node, normalization of the target entity profile data based on the action metrics;
parsing, by the PSS node, the normalized data and deriving a plurality of classifying features;
generating, by the PSS node, a feature vector based on the plurality of classifying features;
ingesting, by the PSS node, the feature vector into the ML module coupled to an Artificial Neural Network (ANN);
receiving, by the PSS node, a plurality of predictive scoring parameters from at least one entity scoring predictive model generated by the ML module using outputs of the ANN based on the feature vector;
generating, by the PSS node, at least one score for the at least one entity node based on the plurality of predictive scoring parameters;
recording the predictive scoring parameters, and the related recommendations and a loan approval predicted verdict on a permissioned blockchain ledger along with the at least one feature vector;
retrieving at least one predictive scoring parameter from the permissioned blockchain responsive to a consensus among the at least one entity node, the PSS node and the plurality of the remote nodes associated with the at least one target entity node onboarded onto the permissioned blockchain; and
executing a smart contract and generating at least one NFT corresponding to the target entity scoring report comprising predictive scoring parameters and related recommendations and a loan approval predicted verdict on the permissioned blockchain.

12. The method of claim 11, further comprising:
querying a local database to retrieve local historical entity-related data based on the plurality of classifying features; and
generating a feature vector based on the plurality of classifying features and the local historical entity-related data.

13. The method of claim 12, further comprising:
querying a remote database to retrieve external historical entities-related data based on the plurality of classifying features, wherein the entities-related data corresponds to a plurality of entities comprising parameters matching parameters of the at least one target entity; and
generating a feature vector based on the plurality of classifying features and the local historical entity-related data combined with the external historical entities-related data.

14. The method of claim 11, further comprising continuously monitoring incoming target entity profile data to determine if at least one value of target entity profile data parameters deviates from a previous value of a corresponding target entity profile data parameter by a margin exceeding a pre-set threshold value.

15. The method of claim 14, further comprising, responsive to the at least one value of target entity profile data parameters deviating from the previous value of the corresponding target entity profile data parameter by the margin exceeding the pre-set threshold value, generating an updated feature vector based on the incoming target entity profile data and generating at least one predictive scoring parameter produced by the at least one entity scoring predictive model in response to the updated feature vector.

16. The method of claim 11, further comprising recording and analyzing the target entity profile data to generate a target entity scoring report comprising predictive scoring parameters and related recommendations and a loan approval predicted verdict.

17. (canceled)

18. (canceled)

19. (canceled)

20. A non-transitory computer-readable medium comprising instructions, that when read by a processor, cause the processor to perform:
acquiring target entity profile data from the at least one target entity node, the target entity profile data comprising action metrics associated with the at least one target entity and the plurality of remote nodes related to at least one target entity node;
performing normalization of the target entity profile data based on the action metrics;
parsing the normalized data and deriving a plurality of classifying features; generating a feature vector based on the plurality of classifying features; ingesting the feature vector into a machine-learning (ML) module coupled to
an Artificial Neural Network (ANN);
receiving a plurality of predictive scoring parameters from at least one entity scoring predictive model generated by the ML module using outputs of the ANN based on the feature vector;
generating at least one score for the at least one entity node based on the plurality of predictive scoring parameters;
recording the predictive scoring parameters, and the related recommendations and a loan approval predicted verdict on a permissioned blockchain ledger along with the at least one feature vector;
retrieving at least one predictive scoring parameter from the permissioned blockchain responsive to a consensus among the at least one entity node, the PSS node and the plurality of the remote nodes associated with the at least one target entity node onboarded onto the permissioned blockchain; and
executing a smart contract and generating at least one NFT corresponding to the target entity scoring report comprising predictive scoring parameters and related recommendations and a loan approval predicted verdict on the permissioned blockchain.
